(19) United States
(12) Patent Application Publication
(10) Pub. No.: US 2011/0069168 A1
(43) Pub. Date: Mar. 24, 2011

(54) VEHICLE SURVEILLANCE SYSTEM FOR USE IN PARKING LOTS

(76) Inventor: Chia-Chun TSOU, Taipei County (TW)

(21) Appl. No.: 12/888,303

(22) Filed: Sep. 22, 2010

(30) Foreign Application Priority Data
Sep. 23, 2009 (TW) 098132030

(51) Int. Cl. H04N 7/18

(52) U.S. Cl. 348/143; 348/E07.085

(57) ABSTRACT

A vehicle surveillance system for installation in a parking area includes an image capture device, a calculating unit and an alarm processing unit. The image capture device is provided for capturing image data from the parking area. The calculating unit is coupled to the image capture device for detecting whether an abnormal event of the vehicle occurs in the parking area or not. The alarm processing unit is coupled to the calculating unit and includes an alert notification module. The alert notification module is configured to be activated when the abnormal event of the vehicle is detected by the calculating unit.

### BACKGROUND OF INVENTION

1. Field of Invention

The present invention relates generally to a smart vehicle surveillance system, and more particularly to a vehicle surveillance system for use in a parking lot.

2. Related Prior Art

A conventional parking lot surveillance system is equipped with cameras for security personnel to monitor vehicle status in a parking lot. Typical prior art surveillance cameras record hundreds of hours of moving images onto video tape which must be monitored by people in order to tell if something suspicious occurred. Most of the video data is useless because nothing interesting is occurring. These cameras may record every detail occurred in the parking lot for further crime investigation. However, when an abnormal event of the vehicle does occur, no instant action will be taken for the vehicle since the security personnel or related people may not be watching the monitor at that moment. The vehicle remains insecure under the conventional parking lot surveillance system.

### SUMMARY OF INVENTION

It is an object of the present invention to provide a vehicle surveillance system for installation in a parking lot to ensure that the vehicle in the parking lot is secure.

It is another object of the present invention to provide a vehicle surveillance system that is completely automatic. That is, no or little manpower is needed with such system for vehicle security. Manpower costs for vehicle security can therefore be reduced.

The present invention is directed to an intelligent vehicle surveillance system for installation in a parking area, such as a parking lot or a parking space. The vehicle surveillance system includes an image capture device, a calculating unit and an alarm processing unit. The image capture device is provided for capturing image data from the parking area. The calculating unit is coupled to the image capture device for detecting whether an abnormal event of the vehicle occurs in the parking area or not. The alarm processing unit is coupled to the calculating unit and includes an alert notification module. When the abnormal event of the vehicle is detected by the calculating unit, the alert notification module will be activated immediately to notify a security guard or the vehicle owner of the abnormal event in a timely manner for further processing.

Specifically, the calculating unit is configured to recognize a movable object from a static background according to the captured image data of the image capture device.

Further features and advantages of the present invention will be appreciated by review of the following detailed description of the invention.

### BRIEF DESCRIPTION OF DRAWING

The invention is illustrated by the accompanying drawing in which corresponding parts are identified by the same numerals and in which:

FIG. 1 is a block diagram of a vehicle surveillance system according to the preferred embodiment of the present invention.

### DETAILED DESCRIPTION OF PREFERRED EMBODIMENT

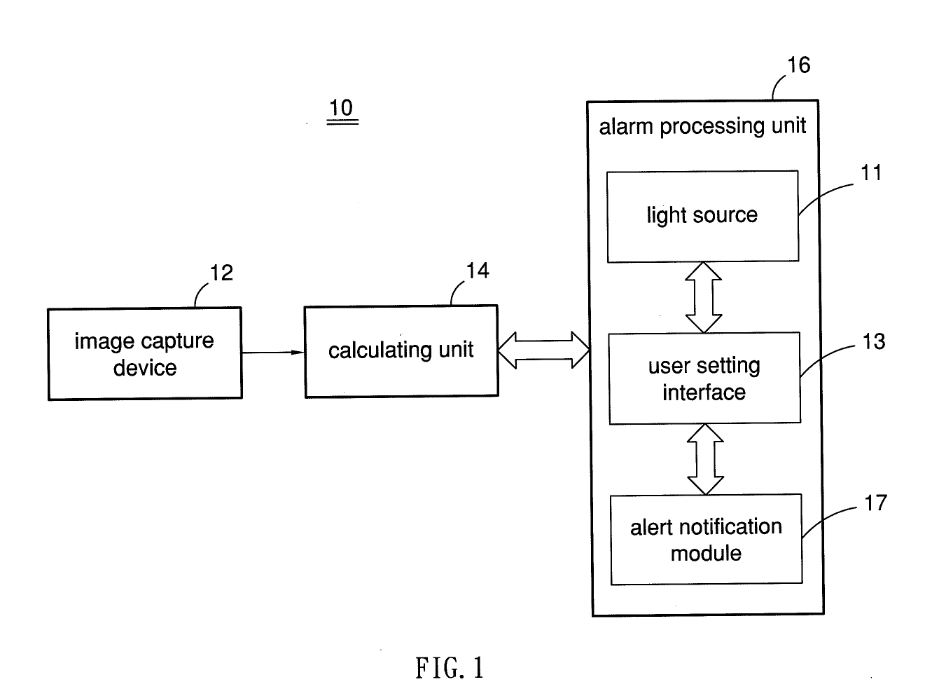

Referring now to FIG. 1 of the drawing, a vehicle surveillance system 10 for installation in a parking area in accordance with the preferred embodiment of the invention includes an image capture device 12, a calculating unit 14 coupled to the image capture device 12, and an alarm processing unit 16 coupled to the calculating unit 14.

In this embodiment, the image capture device 12, such as a CCD (Charged Coupled Device) camera, is configured for capturing image data from the parking area and transferring the captured image data to the calculating unit 14.

The calculating unit 14 cooperates with the image capture device 12 to monitor the parking area and detect whether an abnormal event of the vehicle occurs in the parking area or not. Specifically, the calculating unit 14 can recognize a movable object from a static background according to the captured image data of the image capture device 12. Therefore, when a vehicle, a person or any unusual object moves into the parking area, the calculating unit 14 can identify what the movable object is. More specifically, the calculating unit 14 can distinguish a human body from the vehicle. Upon concluding that the movable object is truly the vehicle according to its dynamic characteristic, the calculating unit 14 further recognizes shape, color and license plate of the vehicle. Afterward, the calculating unit 14 sends the detected and analyzed result to the alarm processing unit 16.

The alarm processing unit 16 includes a light source 11, a user setting interface 13 and an alert notification module 17. The light source 11 is provided for illumination of the parking area to maintain enough lighting when the light is too dim, such as at night, for the image capture device 12 to capture enough-quality image data for further recognition by the calculating unit 14.

The user setting interface 13, coupled with the alert notification module 17, is provided to allow the vehicle owner to set up contact information and click in the relevant window to bring the vehicle under surveillance of the system. Once the vehicle is under surveillance of the system, the calculating unit 14 detects whether any passenger or unusual object approaches the monitored vehicle according to the captured image data of the image capture device 12, and then tracks the activities of the passenger or the object to analyze whether the vehicle is in danger or not.

If the calculating unit 14 detects that the passenger or object remains at the parking area rather unusually, the calculating unit 14 concludes that an abnormal event of the monitored vehicle occurs in the parking area. For instance, in the case where a thief or a dangerous article is detected by the calculating unit 14, the alert notification module 17 of the alarm processing unit 16 will be activated to send a warning message to notify the security personnel or the vehicle owner according to the contact information of the event. The security personnel or the vehicle owner can then judge according to the warning message and take instant action if necessary.

The construction of vehicle surveillance system as described above is thus far largely conventional. According to the present invention, this configuration utilizes motion detection and track technologies to detect whether an abnormal event of the monitored vehicle occurs or not and thereby automatically inform the related people to make sure that the vehicle is secure.

It will be appreciated that although a particular embodiment of the invention has been shown and described, modifications may be made. It is intended in the claims to cover such modifications which come within the spirit and scope of the invention.

The invention claimed is:

1. A vehicle surveillance system for installation in a parking area, comprising:
an image capture device for capturing image data from the parking area;
a calculating unit coupled to the image capture device for detecting whether an abnormal event of the vehicle occurs in the parking area or not; and
an alarm processing unit coupled to the calculating unit and including an alert notification module; the alert notification module configured to be activated when the abnormal event of the vehicle is detected by the calculating unit.

2. The vehicle surveillance system of claim 1, wherein the calculating unit is configured to recognize a movable object from a static background according to the captured image data of the image capture device.

3. The vehicle surveillance system of claim 2, wherein the calculating unit is further configured to distinguish a human body from the vehicle.

4. The vehicle surveillance system of claim 3, wherein the calculating unit is further configured to recognize shape, color and license plate of the vehicle.

5. The vehicle surveillance system of claim 4, wherein the alarm processing unit includes a user setting interface that allows an owner of the vehicle to set up contact information and bring the vehicle under surveillance of the system.

6. The vehicle surveillance system of claim 1, wherein the alarm processing unit includes a light source for illumination of the parking area so as to maintain enough lighting for image capturing.
